(19) United States
(12) Patent Application Publication
(10) Pub. No.: US 2010/0142231 A1
(43) Pub. Date: Jun. 10, 2010

(54) Control Methods and Integrated Circuits for Controlling Power Supply

(76) Inventors: Ming-Nan Chuang, Hsin-Chu (TW); Yu-Bin Wang, Hsin-Chu (TW)

Correspondence Address: NORTH AMERICA INTELLECTUAL PROPERTY CORPORATION, P.O. BOX 506, MERRIFIELD, VA, 22116, US

(21) Appl. No.: 12/578,601

(22) Filed: Oct. 14, 2009

(30) Foreign Application Priority Data
Dec. 4, 2008 (TW) 097147105

(51) Int. Cl. H02M 3/335

(52) U.S. Cl. 363/21.15

(57) ABSTRACT

Integrated circuits for controlling power supplies and relevant control methods are disclosed. A controller generates a control signal to control a power switch. A feedback pin of an integrated circuit receives an external feedback signal representing an output voltage signal of a power supply. Controlled by the control signal, a transferring circuit transfers the feedback signal to the controller when the power switch is off. When the power switch is on, a clamping circuit clamps the voltage of the feedback signal at a predetermined value to avoid the controller from being influenced by the feedback signal.

### BACKGROUND OF THE INVENTION

1. Field of the Invention

The present invention relates to a power control integrated circuit and the related control methods, and more particularly, to a power control integrated circuit of a power supply and the related control methods.

2. Description of the Prior Art

Power supplies such as AC-to-DC converters or DC-to-DC converters are common electronic devices for generating constant voltage source or constant current source to power electronic devices that require specific power management. Since the upgrade for the energy efficiency has been demanded in recent years continuously, the electrical energy conversion competence of the power supplies has become a major subject. How to avoid unnecessary power consumption during power conversion is a goal the circuit designers pursue.

FIG. 1 is a diagram illustrating a conventional power supply with an architecture of a flyback converter. Power control integrated circuit 100 controls power switch Q₁ through pin GATE. When power switch Q₁ is turned on, power signal V_{IN} starts charging transformer T1 causing the current flowing through the primary winding of transformer T1 to increase over time. When power switch Q₁ is turned off, the stored electrical energy in transformer T1 starts being released through the induced current in the secondary winding of transformer T1, charging output capacitor C_{O}. It is defined in this specification that a power supply operates in an energizing state if the energy of an inductive device, such as an inductor or a transformer, is increasing, and in a de-energizing state if the energy of the inductive device is decreasing.

Resistors R₁ and R₂, and pin FB together provides a feedback mechanism; power control integrated circuit 100 can monitor the magnitude of output power signal V_{OUT} to control power switch Q₁ and thus decide the charging energy through transformer T1 to output capacitor C_{O}. Generally speaking, the feedback mechanism is to maintain output power signal V_{OUT} to be as close to an expected value as possible.

However, as shown in FIG. 1, resistors R₁ and R₂ also provide a power leakage path, through which the charge in output capacitor C_{O} leaks to ground. Regardless of whether power control integrated circuit 100 turns on power switch Q₁ or not, the stored electrical energy of output capacitor C_{O} is constantly and unnecessarily wasted through the power leakage path. Hence, such the power leakage path should be eliminated as much as possible.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional power supply.

FIG. 2 is a diagram illustrating a power supply of an embodiment according to the present invention.

FIG. 3 is a timing diagram illustrating the relation between signals of FIG. 2.

FIG. 4 is a diagram illustrating a power supply of an embodiment according to the present invention.

FIG. 5 is a diagram illustrating a power supply of an embodiment according to the present invention.

FIG. 6 is a timing diagram illustrating the timing relation between signals of FIG. 4 and FIG. 5.

### DETAILED DESCRIPTION

Further objects of the present invention and more practical merits obtained by the present invention will become more apparent from the description of the embodiments which will be given below with reference to the accompanying drawings. For explanation purposes, components with equivalent or similar functionalities are represented by the same symbols. Hence components of different embodiments with the same symbol are not necessarily identical. Here, it is to be noted that the present invention is not limited thereto.

In the following descriptions, VXX represents the voltage of signal V_{XX}, and RX represents the impedance of resistor R_{X}.

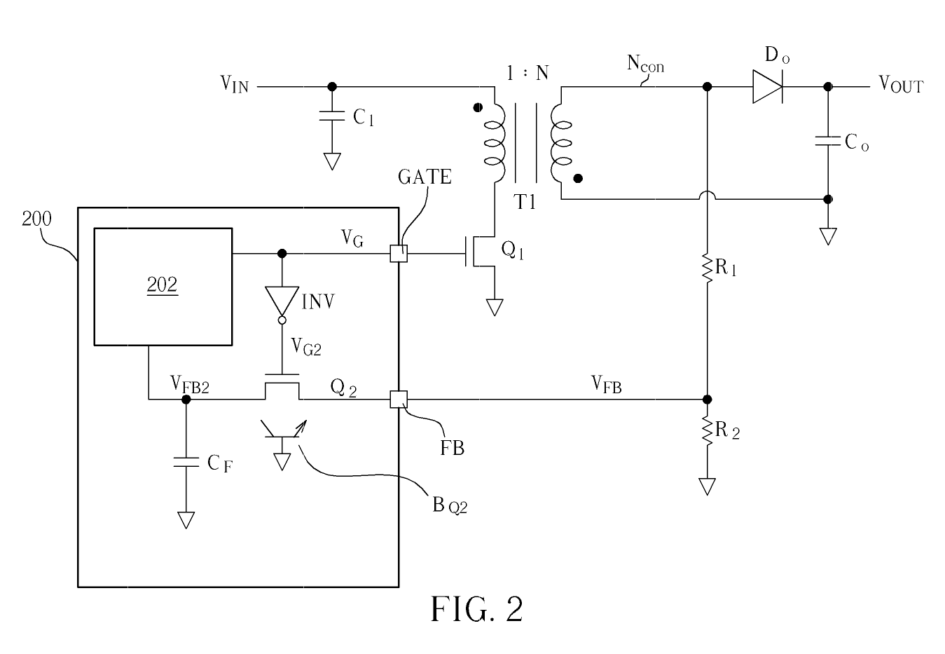

FIG. 2 is a diagram illustrating a power supply of an embodiment according to the present invention. Controller 202 of power control integrated circuit 200 generates signal V_{G} for controlling power switch Q₁ to turn on/off through pin GATE. Switch Q₂ is coupled between controller 202 and pin FB, and is controlled by signal V_{G2}. Signal V_{G2} is generated by inverter INV which receives the signal V_{G}. Capacitor C_{F} is coupled to controller 202 and switch Q₂.

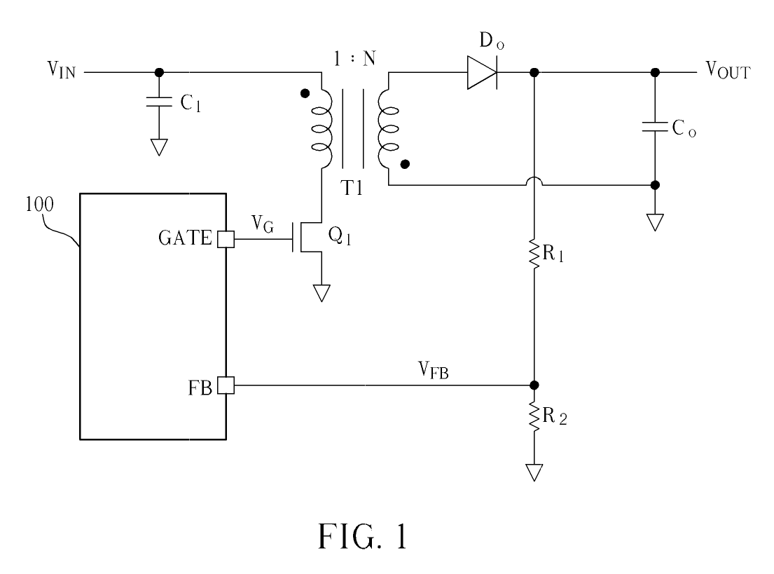

Similar to the operations in FIG. 1, when power switch Q₁ of FIG. 2 is turned on, power supply of FIG. 2 operates in an energizing state. When power switch Q₁ of FIG. 2 is turned off, power supply of FIG. 2 operates in a de-energizing state.

Different from FIG. 1, feedback resistors R₁ and R₂ in FIG. 2 provide a feedback mechanism by monitoring node N_{CON}, which is the connection node between diode D_{O} and the secondary winding of transformer T1. Diode D_{O}, acting as a rectifier, blocks the reverse current flowing from output capacitor C_{O} to resistor R₁. Hence the constant power leakage path of FIG. 1 does not exist in FIG. 2.

When the power supply of FIG. 2 operates in the de-energizing state, the energy stored in the secondary winding of transformer T1 is released to charge output capacitor C_{O}, causing diode D_{O} to be turned on or forward biased. Hence, signal V_{COM} on node N_{CON} is constantly higher than output voltage signal V_{OUT} by around 0.7 volt, the forward-biased voltage of a diode. The higher the output voltage signal V_{OUT}, the more representative the signal V_{COM} on node N_{CON} to be output voltage signal V_{OUT}. Feedback signal V_{FB} is the result of signal V_{COM} passing through the voltage divider composed of resistors R₁ and R₂. Therefore, in the de-energizing state, feedback signal V_{FB} varies in response to the variation of output voltage signal V_{OUT}, or in other words, feedback signal V_{FB} approximately represents output voltage signal V_{OUT}.

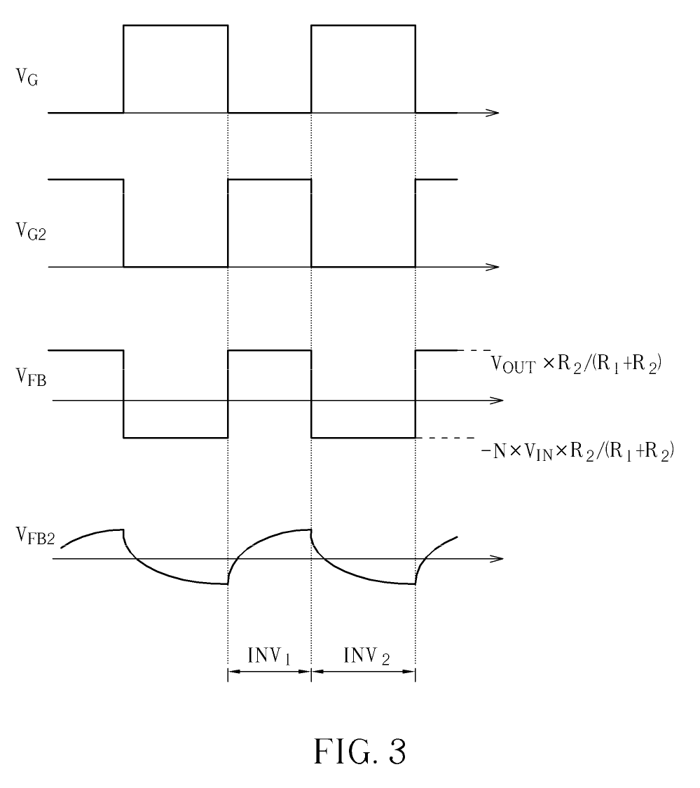

Please refer to both FIGS. 2 and 3. FIG. 3 is a timing diagram illustrating the relation between signals V_{G}, V_{G2}, V_{FB} and V_{FB2} of FIG. 2, wherein signal V_{FB2} represents to the voltage across capacitor C_{F}. In the de-energizing state, power control integrated circuit 200 controls signal V_{G} to be at logic “0” and turn off power switch Q₁. Meanwhile, V_{G2} is at logic “1”, due to inverter INV, and turns on switch Q₂. Therefore, switch Q₂ functions to provide a signal path from pin FB to controller 202, allowing controller 202 to switch power switch Q₁ according to feedback signal V_{FB}. As shown in interval INT₁ of FIG. 3, in the de-energizing state, the voltage of feedback signal V_{FB} is deemed to be a constant positive value and can be approximately represented by the formula below:

VFB=VOUT×R2/(R1+R2) (1)

It is presumed that, at the start of interval INT₁, signal V_{FB2} is at a lower voltage level compared to signal V_{FB}. As shown in FIG. 3, due to the current flowing through the current path provided by switch Q₂, the voltage level of signal V_{FB2} increases with time and approaches the voltage level of signal V_{FB} gradually. In other words, switch Q₂ passes on feedback signal V_{FB} to generate signal V_{FB2} forwarded to controller 202, and then controller 202 generates signal V_{G} according to signal V_{FB2} to control power switch Q₁.

Interval INT₂ of FIG. 3 indicates power control integrated circuit 200 operating in the de-energizing state. In the de-energizing state, power control integrated circuit 200 controls signal V_{G} to be high for turning on power switch Q₁ and signal V_{G2} low for turning off switch Q₂. In the meantime, feedback signal V_{FB}, equivalent to the induced voltage across the secondary winding of transformer T1, is a constant negative value. In the de-energizing state, the voltage of feedback signal V_{FB} can be approximately represented by the formula below:

VFB=−N×VIN×R2/(R1+R2) (2)

where N represents the winding ratio of the secondary winding to the primary winding of transformer T1. The intention of turning off switch Q₂ is to isolate feedback signal V_{FB} and signal V_{FB2}, maintaining signal V_{FB2} to approximately equal to feedback signal V_{FB} at the end of interval INT₁. However, as shown in FIG. 2, Bipolar Junction Transistor (BJT) B_{Q2} parasitizes in switch Q₂. In interval INT₂, feedback signal V_{FB}, which is at a negative voltage level in the charging operation, is likely to trigger BJT B_{Q2} to turn on, causing capacitor C_{F} to release the stored charge. Hence, as shown in interval INT₂ of FIG. 3, signal V_{FB2}, the voltage drop across capacitor C_{F}, declines gradually over time.

If signal V_{FB2} can retain the same voltage level as feedback signal V_{FB} in the energizing state, signal V_{FB2} can correctly represent output voltage signal V_{OUT} and provide controller 202 with correct feedbacks, allowing the feedback mechanism to function properly. However, as shown in FIG. 3, due to the leakage generated by a BJT, signal V_{FB2} is not a correct representation of output voltage signal V_{OUT}, possibly resulting in an improperly functioning feedback mechanism of power control integrated circuit 200. Consequently, output voltage signal V_{OUT} of FIG. 2 may be unable to retain the desired value.

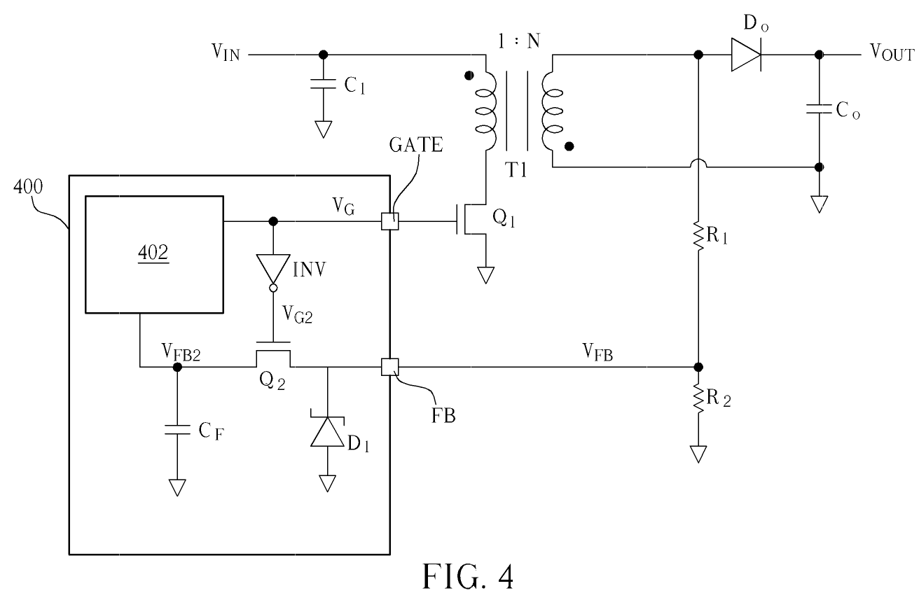

FIG. 4 is a diagram illustrating a power supply of an embodiment according to the present invention. For brevity, further discussion on the repeating components between FIG. 2 and FIG. 4 thereof is omitted. Different from FIG. 2, power control integrated circuit 400 comprises an additional Zener diode D₁, coupled between pin FB and ground end. Zener diode possesses a relatively low forward-biased voltage, such as 0.1 volt, and is utilized as a clamp circuit. In the energizing state, Zener diode D₁ can clamp signal V_{FB} to be not lower than the forward-biased voltage, in negative magnitude, of Zener diode D₁. For instance, in the charging operation, if the forward bias voltage of Zener diode D₁ is 0.1 volt, feedback signal V_{FB} is then clamped and fixed at −0.1 volt. Hence, the base-to-emitter voltage (V_{BE}) of BJT B_{Q2} which parasitizes in switch Q₂ is only 0.1 volt, being not able to trigger BJT B_{Q2}, which generally needs V_{BE} to be higher than 0.7 volt for triggering. Therefore, when operating in the energizing state, signal V_{FB2} or controller 402 can avoid being influenced by feedback signal V_{FB}, and signal V_{FB2} can approximately retain the level of feedback signal V_{FB} at the end of the previous de-energizing state.

When in the de-energizing state, the reverse breakdown voltage of Zener diode D₁ of FIG. 4 is preferred to be set at a level that is higher than feedback signal V_{FB}. Hence, when in the de-energizing state, Zener diode of FIG. 4 will not be broken down, forming an open circuit. An artisan of ordinary skill in the art can easily extrapolate the operation principle and functional behavior of the power supply in the de-energizing state of FIG. 4, according to the technical description of the power supply of FIG. 2.

When in the de-energizing state, signal V_{FB2} in FIG. 4 continues to increase and approach to the level of feedback signal V_{FB}. When in the energizing state, signal V_{FB2} is approximately equal to the level of feedback signal V_{FB} at the end of the previous de-energizing state. Hence, signal V_{FB2} of FIG. 4 can be extrapolated to correctly reflect feedback signal V_{FB} in the de-energizing state. In other words, signal V_{FB2} of FIG. 4 is an accurate representation of output voltage signal V_{OUT}, providing proper feedbacks to controller 402 for switching power switch Q₁. Subsequently output voltage signal V_{OUT} is able to retain an expected value.

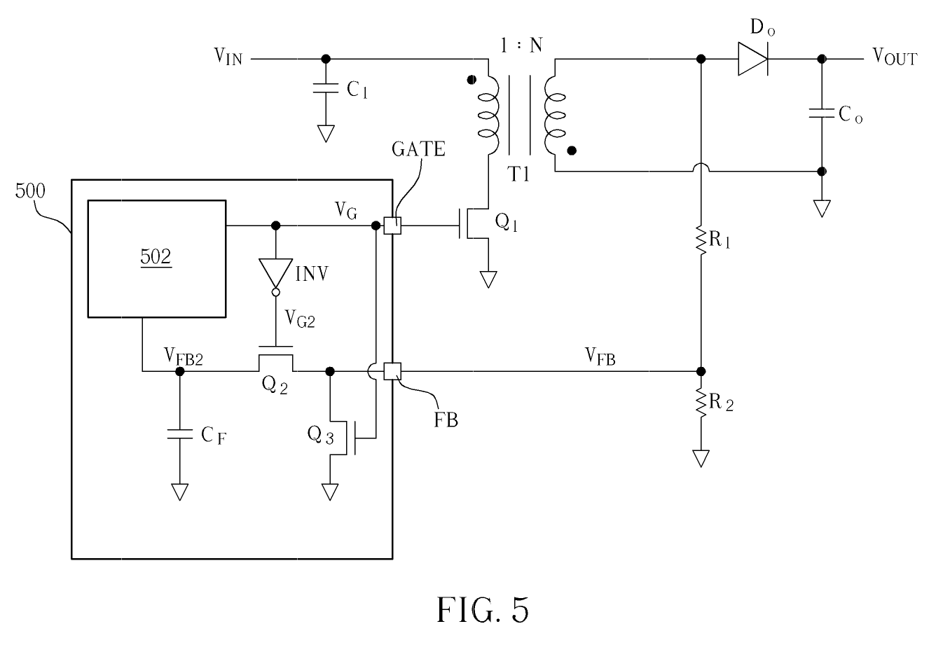

FIG. 5 is a diagram illustrating a power supply of another embodiment according to the present invention. For brevity, further discussion on the repeating components between FIG. 4 and FIG. 5 thereof is omitted. Zener diode D₁ in FIG. 4 is replaced by switch Q₃ in FIG. 5. The control end of switch Q₃ is coupled to controller 502; hence signal V_{G} controls the on/off states of switch Q₃. Switch Q₃ functions as a clamp circuit. In the energizing state, switch Q₃ is turned on along with power switch Q₁, causing pin FB to be short-circuited to ground end GND, and consequently feedback signal V_{FB} is being clamped to 0 volt. As a result, the base-to-emitter voltage of BJT B_{Q2} which parasitizes in switch Q₂ is also 0 volt; hence BJT B_{Q2} is kept turned off. Therefore, when in the energizing state, signal V_{FB2} or controller 502 are not influenced by feedback signal V_{FB}.

When in the de-energizing state, switch Q₃ of FIG. 5 is kept turned off, forming an open circuit. An artisan of ordinary skill in the art can easily extrapolate the operation principle and functional behavior of the power supply of FIG. 5 in the de-energizing state, according to the technical description of the power supply of FIG. 2.

Similar to FIG. 4, signal V_{FB2} in FIG. 5 correctly reflects the voltage level of feedback signal V_{FB} in the discharging operation. In other words, signal V_{FB2} of FIG. 5 is a proper representation of output voltage signal V_{OUT}. Signal V_{FB2} provides proper feedbacks to controller 502 for controlling the on/off operation of power switch Q₁ and subsequently allowing output voltage signal V_{OUT} to retain an expected value.

In integrated circuits, the regions where the negative voltage exists are usually prone to emit electrons and the component characteristics of other regions are being affected accordingly. Hence, in FIG. 5, by clamping feedback signal V_{FB} to 0 volt, the component characteristics of power supply integrated circuit 500 are stabilized accordingly.

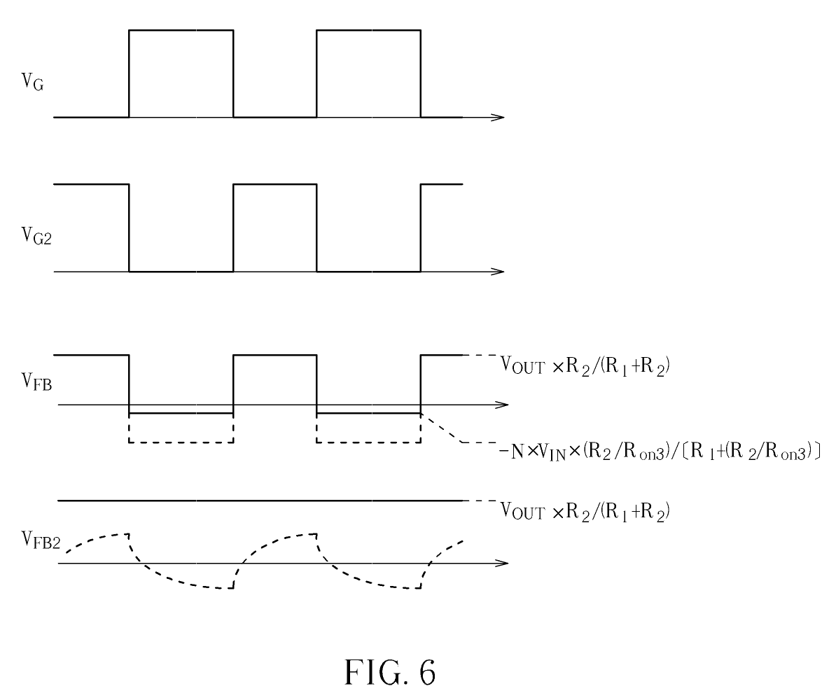

FIG. 6 is a timing diagram illustrating the timing relation between signals V_{G}, V_{G2}, V_{FB} and V_{FB2} in FIG. 4 and FIG. 5. In FIG. 6, when in the charging operation, feedback signal V_{FB} is being clamped to a value that is close to 0 volt due to Zener diode D₁ in FIG. 4 or switch Q₃ in FIG. 5, no longer at a negative voltage level like that in FIG. 3. As the base-to-emitter voltage of BJT B_{Q2} is lower than 0.7 V, BJT B_{Q2} is prevented from being turned on. In FIG. 6, signal V_{FB2} does not drift up and down like that in FIG. 3 and can approximately be retained at a level that is equal to feedback signal V_{FB} of the de-energized state, which is VOUT×R2/(R1+R2). Hence feedback signal V_{FB2} in FIG. 4 and FIG. 5 can correctly represent voltage output signal V_{OUT}, for providing appropriate feedbacks to the controller.

Even the invention is exemplified by flyback converters, it is not limited to and can be applied to converters with other architectures, such as buck converters, boost converters, buck-boost converter, and the like.

Those skilled in the art will readily observe that numerous modifications and alterations of the device and method may be made while retaining the teachings of the invention.

What is claimed is:

1. A control method, for a power supply to output a voltage output signal, the power supply alternatively operating in a first operation and a second operation, the control method comprising:
receiving a feedback signal, capable of representing the voltage output signal;
providing a signal path when the power supply operates in the first operation, for controlling the power supply according to the feedback signal; and
terminating the provided signal path and clamping the feedback signal approximately to be a predetermined value when the power supply operates in the second operation, so as to prevent the feedback signal from affecting the power supply.

2. The control method of claim 1, wherein clamping the feedback signal approximately to be the predetermined value comprises:
utilizing a Zener diode for clamping the feedback signal approximately to be the predetermined value.

3. The control method of claim 1, wherein the power supply comprises a power switch, and terminating the provided signal path when the power supply operates in the second operation comprises:
generating a control signal for controlling the power switch;
terminating the provided signal path according to the control signal; and
turning on a switch according to the control signal to provide a path to a ground end for clamping the feedback signal.

4. The control method of claim 1, wherein the power supply comprises a power switch, and providing the signal path when the power supply operates in the first operation comprises:
generating a control signal for controlling the power switch; and
turning on a switch according to the control signal, so that the feedback signal influences a controller, wherein the controller generates the control signal.

5. The control method of claim 1, wherein the first operation is de-energizing state and the second operation is energizing state.

6. A power control integrated circuit, comprising:
a controller, for generating a control signal to control a power switch;
a signal feedback pin, for receiving a feedback signal externally, the feedback signal representing an output voltage signal of a power supply;
a transmission circuit, controlled by the control signal, for transmitting the feedback signal to the controller when the power switch is turned off; and
a clamp circuit for clamping the feedback signal to a predetermined value when the power switch is turned on so as to prevent the feedback signal from affecting the controller.

7. The power control integrated circuit of claim 6, wherein the clamp circuit comprises a Zener diode coupled between the signal feedback pin and a ground end.

8. The power control integrated circuit of claim 6, wherein the clamp circuit comprises a switch controlled by the control signal and coupled between the signal feedback pin and a ground end.

9. The power control integrated circuit of claim 6, wherein the transmission circuit comprises:
a switch, controlled by the control signal and coupled between the signal feedback pin and the controller; and
a capacitor, comprising an end coupled to the switch and the controller.

10. The power control integrated circuit of claim 6, wherein the power switch is coupled to a transformer; when the power switch is turned on, the transformer starts charging; when the power switch is turned off, the transformer starts discharging.

11. A power supply, comprising:
a power control integrated circuit of claim 6;
an output capacitor, for generating the output voltage signal;
an inductor, comprising a first end;
a voltage divider, coupled between the first end and a ground end, for generating the feedback signal; and
a rectifier, coupled between the output capacitor and the voltage divider, for blocking current flowing from the output capacitor to the voltage divider.

12. The power of claim 11, wherein the power supply is a flyback converter, the flyback converter comprises a transformer, and the inductor is a secondary winding of the transformer.
